(19) United States
(12) Patent Application Publication
(10) Pub. No.: US 2013/0198644 A1
(43) Pub. Date: Aug. 1, 2013

(54) APPARATUS AND METHOD FOR PROVIDING USER INTERFACE PAGE IN HOME NETWORK

(71) Applicants: Young-Wan So, Gyeonggi-do (KR); Young-Sun Ryu, Gyeonggi-do (KR); Jae-Yeon Song, Seoul (KR)

(72) Inventors: Young-Wan So, Gyeonggi-do (KR); Young-Sun Ryu, Gyeonggi-do (KR); Jae-Yeon Song, Seoul (KR)

(73) Assignee: SAMSUNG ELECTRONICS CO LTD, GYEONGGI-DO (KR)

(21) Appl. No.: 13/824,854

(22) PCT Filed: Oct. 14, 2011
(86) PCT No.: PCT/KR11/07670

§ 371 Date: Mar. 18, 2013

(30) Foreign Application Priority Data
Oct. 15, 2010 (KR) 10-2010-0100736

(51) Int. Cl. H04L 12/24

(52) U.S. Cl. CPC H04L 41/22
USPC 715/740

(57) ABSTRACT

A method and an apparatus for providing a User Interface (UI) page in a home network are provided. At a first client receives a UI page from a server. A UI state of a current UI page is transmitted from the first client to the server or a second client to store the UI state of the current UI page in the server or the second client, when a UI state storage event for storing the UI state of the current UI page occurs. When a request for restoration of the UI state is generated by the second client, the UI state is controlled according to a capability of the second client by the server or the second client, and the controlled UI state is applied to the UI page received from the server by the second client.

### PRIORITY

This application is a National Phase Entry of PCT International Application No. PCT/KR2011/007670, which was filed on Oct. 14, 2011, and claims priority to Korean Patent Application No. 10-2010-0100736 filed in the Korean Intellectual Property Office on Oct. 15, 2010, the contents of which are incorporated herein by reference.

### BACKGROUND OF THE INVENTION

1. Field of the Invention The present invention relates generally to a home network, and more particularly, to an apparatus and a method for providing a User Interface (UI) page to a Remote User Interface Client (RUIC) in a home network.

2. Description of the Related Art

Several industrial standard organizations such as, for example, Digital Living Network Alliance (DLNA), Home Audio-Video Interoperability (HAVi), and Universal Plug and Play (UPnP), are actively conducting research on home network technology.

Remote User Interface (RUI) technology may be used to control functions of one device using another device in the home network. Typically, the RUI technology is implemented using a client-service architecture in which a Remote User Interface Client (RUIC) downloads a UI page from a Remote User Interface Server (RUIS), so that a user can control the RUIS through the received UI page in the RUIC. The RUIS is included in Customer Premises Equipment (CPE).

FIG. 1 is a diagram illustrating the providing of a UI page from a conventional RUIS to an RUIC.

Referring to FIG. 1, in step 101, an RUIC 100 receives a UI page from an RUIS 150. When it is desired to stop the reception of a desired service while the desired service is being received, the RUIC 100 stores a UI state of a current UI page for the service, in step 103. If the RUIC 100 receives a UI page from the RUIS 150 after a predetermined time, in step 105, it may restore the UI state stored, in step 103, in order to receive the previously received service again and may continuously receive the service, in step 107.

Various web technologies capable of easily storing information (e.g., a UI state) of a client in the RUIC 100 have been developed and supplied. An approach capable of storing information in a client has been developed to create an approach capable of writing and reading the information to and from the client without limiting a storing period.

However, because a UI state is conventionally stored within the RUIC 100, if power of the RUIC 100 is turned-off, it not able to continuously receive the previously received service.

### SUMMARY OF THE INVENTION

The present invention has been made to address at least the above problems and/or disadvantages and to provide at least the advantages described below. Accordingly, an aspect of the present invention provides an apparatus and a method for efficiently providing a UI page in a home network.

Another aspect of the present invention provides an apparatus and a method that may use a UI state of a previously received service by a second RUIC, when power of a first RUIC is turned-off in a home network.

In accordance with an aspect of the present invention, a method for providing a UI page in a home network is provided. A first client receives a UI page from a server. A UI state of a current UI page is transmitted from the first client to the server or a second client to store the UI state of the current UI page in the server or the second client, when a UI state storage event for storing the UI state of the current UI page occurs. When a request for restoration of the UI state is generated by the second client, the UI state is controlled according to a capability of the second client by the server or the second client, and the controlled UI state is applied to the UI page received from the server by the second client.

In accordance with another aspect of the present invention, an apparatus for providing a UI page in a home network is provided. The apparatus includes a first client for receiving a UI page from a server, and transmitting a UI state of a current UI page to the server or a second client to store the UI state of the current UI page in the server or the second client when a UI state storage event for storing the UI state of the current UI page occurs. The apparatus also includes the second client for applying a UI state, having been controlled according to a capability of the second client, to the UI page received from the server when a request for restoring the UI state is generated.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a diagram illustrating the of providing a UI page from a conventional RUIS to an RUIC;

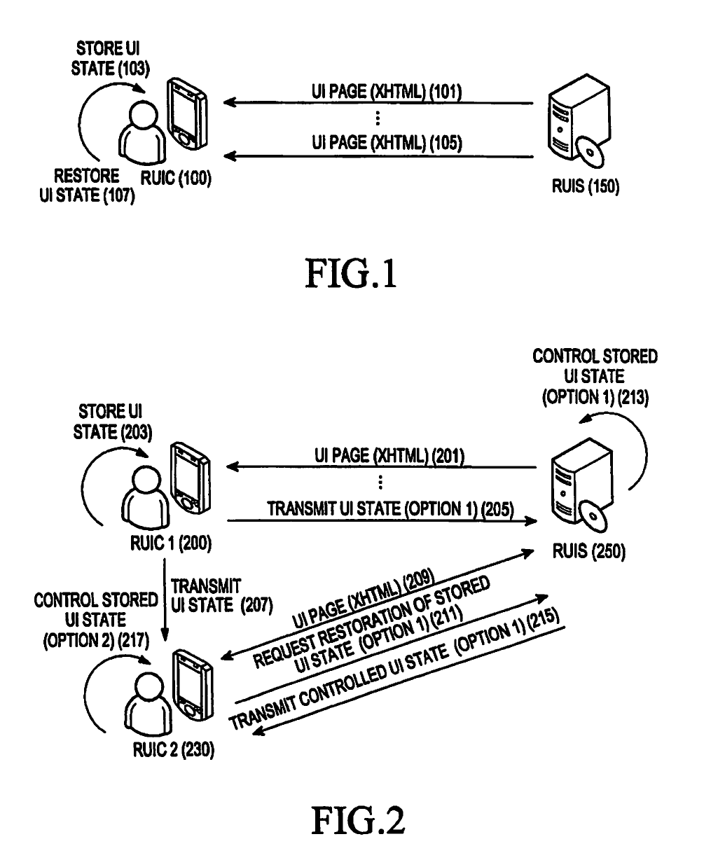

FIG. 2 is a diagram illustrating a method for providing a UI page, according to an embodiment of the present invention;

FIG. 3 is a block diagram illustrating an apparatus for providing a UI page, according to an embodiment of the present invention;

FIG. 4 is a signal flow diagram illustrating an operation of an apparatus for providing a UI page, according to an embodiment of the present invention;

FIG. 5A and FIG. 5B are a flowchart illustrating a method for providing a UI page, according to an embodiment of the present invention; and

FIG. 6 is a diagram illustrating application of a method for providing a UI page, according to an embodiment of the present invention.

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

In an embodiment of the present invention, a UI state for a service received by the RUIC is provided to a second RUIC that allows a user to continuously use a previously received service through the second RUIC, if power of a first RUIC is turned-off in a home network.

An apparatus and a method for providing a UI page according to an embodiment of the present invention are described in detail below with reference to the accompanying drawings.

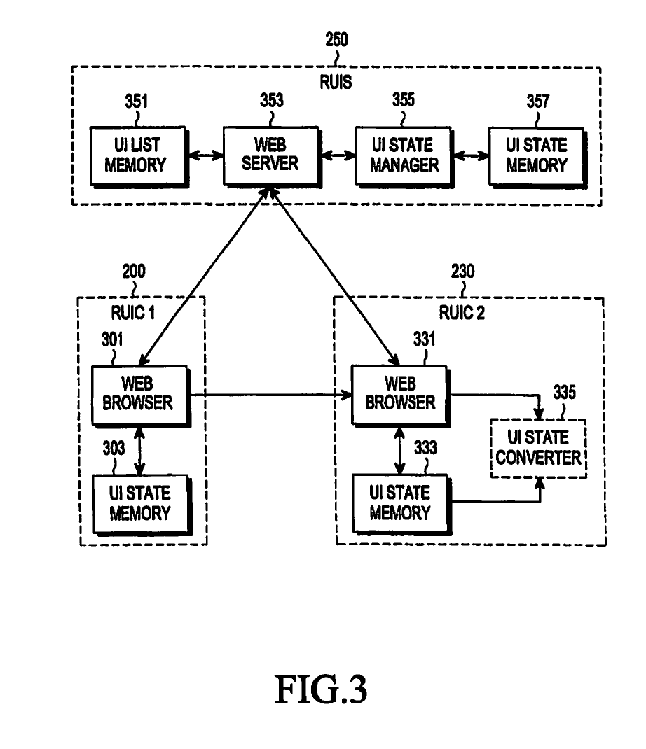

FIG. 2 is a diagram illustrating a method for providing a UI page, according to an embodiment of the present invention.

Referring to FIG. 2, a first RUIC 200 receives an original UI page corresponding to the first RUIC 200 from an RUIS 250, in step 201. When it is desired to stop reception of a desired service while the desired service is being received and to continuously use it later, the first RUIC 200 stores a UI state of a current UI page for the service in the first RUIC 200, in step 203. The first RUIC 200 transmits a UI list to the RUIS 250.

In embodiments of the present invention, the first RUIC 200 transmits a UI state of a current UI page to the RUIS 250, in step 205, or to a second RUIC 230, in step 207.

The first RUIC 200 simultaneously transmits capability information of the first RUIC 200, together with the UI state, to the RUIS 250 or the second RUIC 230.

If the second RUIC 230 makes a request for transmission of an original UI page to the RUIS 250 after receiving a stored UI list from the RUIS 250, the RUIS 250 transmits an original UI page for the second RUIC 230 to the second RUIC 230, in step 209.

The second RUIC 230 determines whether a UI state of the first RUIC 200 is stored in the first RUIC 200. When the UI state of the first RUIC 200 is not stored (option 1), the RUIC 230 requests restoration of the UI state of the first RUIC 200 stored in the RUIS 250, in step 211. The RUIS 250 controls the stored UI state of the first RUIC 200 according to a capability of the second RUIC 230, in step 213, and transmits the controlled UI state of the first RUIC 200 to the second RUIC 230, in step 215.

In contrast, when the UI state of the first RUIC 200 is stored in the first RUIC 200 (option 2), the second RUIC 230 controls the stored UI state of the first RUIC 200 according to the capability of the second RUIC 230, in step 217.

Accordingly, in the above-described embodiments of the present invention, the second RUIC 230 may apply the controlled UI of the first RUIC 200 to an original UI page to continuously provide the previously received service to the user.

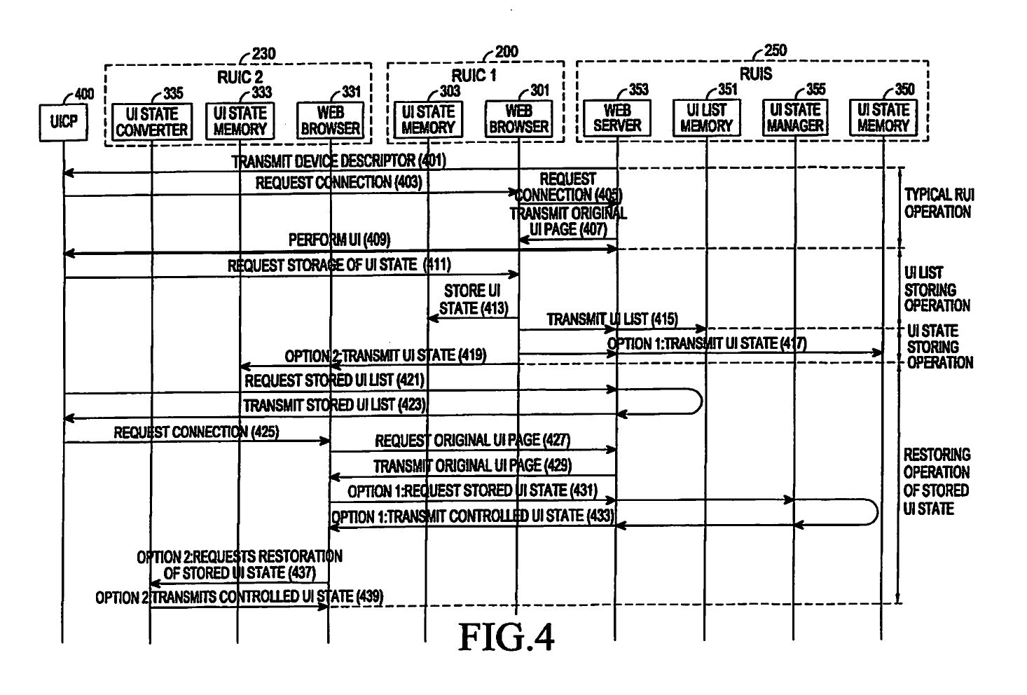

FIG. 3 is a block diagram illustrating an apparatus for providing a UI page, according to an embodiment of the present invention.

Referring to FIG. 3, the apparatus for providing a UI page includes the first RUIC 200, the second RUIC 230, and the RUIS 250. The first RUIC 200 includes a web browser 301 and a UI state memory 303. The second RUIC 230 includes a web browser 331, a UI state memory 333, and a UI state converter 335. The RUIS 250 includes a UI list memory 351, a web server 353, a UI state manager 355, and a UI state memory 357. The first RUIC 200 and the second RUIC 230 typically perform the same function. However, in describing embodiments of the present invention, it is assumed that the first RUIC 200 is a terminal used first by the user, and the second RUIC 230 is a terminal used after power of the first RUIC 200 is turned-off

Web browsers 301 and 331 included in the first and second RUICs 200 and 230 receive and render an original UI page of an eXtensible HyperText Markup Language (XHTML) format from a web server 353 of the RUIS 250, respectively. Further, UI state memories 303 and 333 store a UI state of a currently used UI page, and may store a UI state received from another RUIC. If the second RUIC 230 directly receives the UI state from the first RUIC 200, the UI state converter 335 determines whether the UI state of the first RUIC 200 may be provided with a capability of the second RUIC 230. When the UI state of the first RUIC 200 may not be provided, the UI state converter 335 may control a UI state of the first RUIC 200 according to the capability of the second RUIC 230, and transmit the controlled UI state of the first RUIC 200 to the second RUIC 230 through the web server 353.

When the web server 353, included in the RUIS 250, receives a request for an original UI page from the first RUIC 200 or the second RUIC 230, it transmits an original UI page in an XHTML format. The UI list memory 351 stores a UI list that is able to be provided to the first and second RUICs 200 and 230. The UI state memory 357 stores a UI state that is able to be provided to the first and second RUICs 200 and 230. If the UI state manager 355 receives a request for storage of a UI state from at least one of the first RUIC 200 or the second RUIC 230, it stores the requested UI state of an RUIC. When a UI state of the first RUIC 200 may not be provided with the capability of the second RUIC 230 after receiving a request of a UI page from the second RUIC 230, the UI state manager 355 may control a UI state of the first RUIC 200, according to the capability of the second RUIC 230, and transmit the controlled UI state to the second RUIC 230 through the web server 353.

Accordingly, in an embodiment of the present invention, the second RUIC 230 may apply the controlled UI state to an original UI page to continuously receive a service received previously through the first RUIC 200.

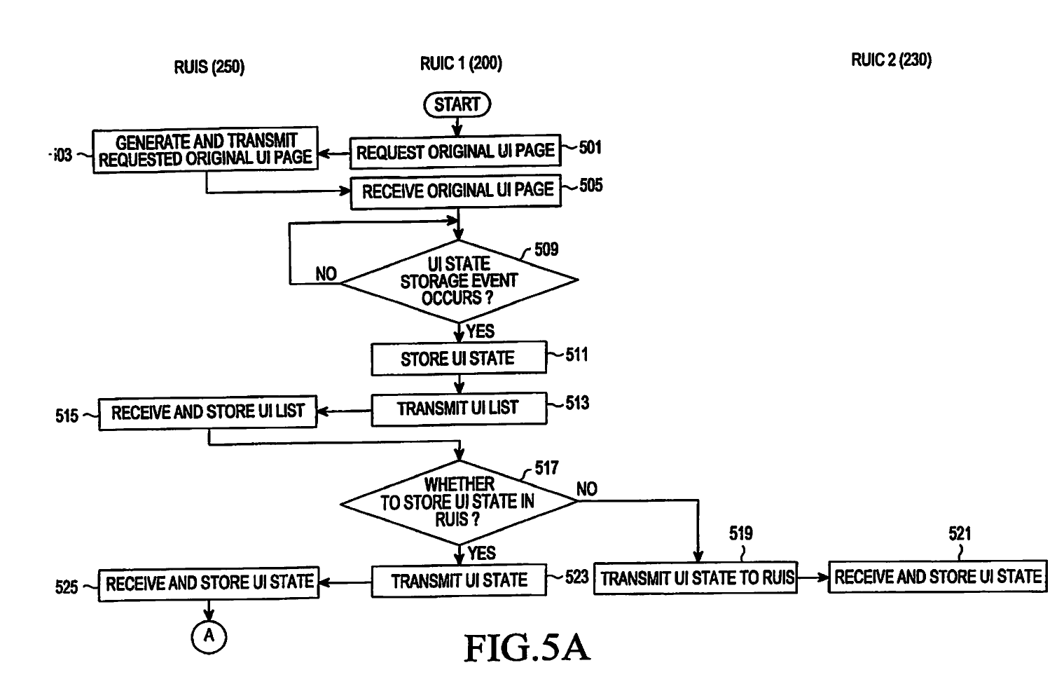

An operation of an apparatus for providing a UI page, according to an embodiment of the present invention, is described in detail below with reference to FIG. 4 in detail.

FIG. 4 is a signal flow diagram illustrating an operation of an apparatus for providing a UI page, according to an embodiment of the present invention. A Unit Interval Control Program (UICP) 400 may be included in the first RUIC 200, the second RUIC 230, the RUIS 250, or a third device not shown in embodiments of the present invention.

Referring to FIG. 4, steps 401 to 409 are a typical RUI operation, and steps 411 to 415 are operations for storing a UI state and a UI list. Steps 417 and 419 are operations for storing a UI state according to embodiments of the present invention, respectively. Steps 421 to 441 correspond to operations for restoring a stored UI state according to the embodiments of the present invention.

When the UICP 400 receives a device descriptor from a web server of the RUIS 250 in step 401, it requests connection to a web browser 301 of the first RUIC 200, in step 403. Subsequently, the web browser 301 of the first RUIC 200 requests an original UI page from the web server 453 according to the connection request, in step 405. The web server 353 transmits the requested original UI page to the web browser 301, in step 407. In step 409, the UICP 400 may receive a UI page through the web browser 301 of the first RUIC 200 to perform UI.

The UICP 400 requests storage of a UI state of a current UI page from the web browser 301 so that it may stop use of a current service and to continuously use it later, in step 411. The web browser 301 transmits the UI state of the current UI page to the UI state memory 303 and stores the UI state of the current UI page therein, in step 413. The web browser 301 transmits a UI list for the UI states to the UI list memory 351 through a web server 353 of the RUIS 250, in step 415. The UI state is stored in the UI state memory 303 in a web cookie format or a similar data format capable of being stored in a client.

The web browser 301 transmits the stored UI state of the first RUIC 200 to the UI state memory 350 through a web server 353 of the RUIS 250, according to an embodiment of the present invention, in step 417, or transmits the stored UI state of the first RUIC 200 to the UI state memory 333 through a web browser 331 of the second RUIC 230, according to another embodiment of the present invention in step 419.

The UICP 410 requests a UI list stored in the web server 353 of the RUIS 250, in step 421. The web server 353 transmits the UI list stored in the UI list memory 351 to the UICP 400, in step 423. The UICP 400 requests connection through the web browser 331 of the second RUIC 230, in step 425. The web browser 331 of the second RUIC 230 requests an original UI page from the web server 353, in step 427, and the web server 353 transmits the requested original UI page to the web browser 331, in step 429.

If the UI state of the first RUIC 200 is stored in the RUIS 250, the web browser 331 of the second RUIC 230 requests the web server 353 of the RUIS 250 to restore the UI state of the first RUIC 200 stored in the UI state manager 355, in step 431. In this case, a restoring request for the stored UI state contains capability information of the second RUIC 230. Accordingly, the UI state manager 355 controls a UI state of the first RUIC 200 stored in the UI state memory 357 according to the capability of the second RUIC 230, and transmits the controlled UI state to the web browser 331, in step 433.

When the UI state of the first RUIC 200 is stored in the second RUIC 230, according to the other embodiment of the present invention, the web browser 331 requests restoration of the UI state of the first RUIC 200 stored in the UI state converter 335, in step 437. The UI state converter 335 reads the UI state of the first RUIC 200 stored in the UI state memory 333, controls the read UI state of the first RUIC 200 according to the capability of the second RUIC 230, and transmits the controlled UI state to the web browser 331, in step 439.

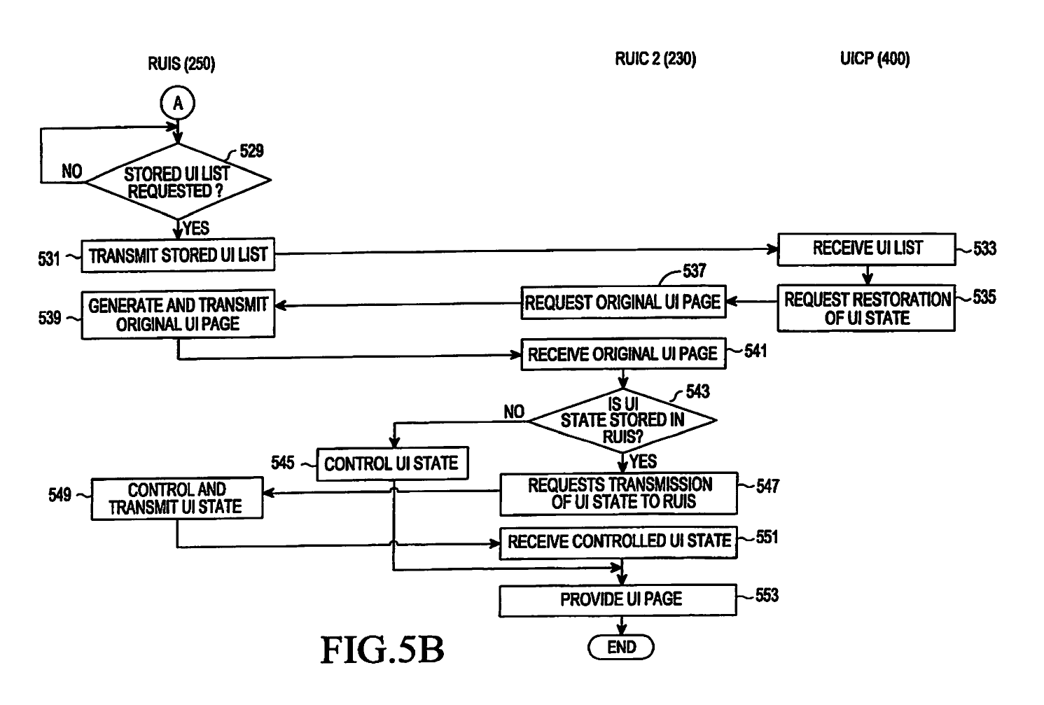

FIG. 5A and FIG. 5B are a flowchart illustrating a method for providing a UI page, according to an embodiment of the present invention.

Referring to FIG. 5A and FIG. 5B, a first RUIC 200 requests an original UI page from an RUIS 250, in step 501. The RUIS 250 generates and transmits the requested original UI page to the first RUIC 200, in step 503. The first RUIC 200 receives the original UI page from the RUIS 250, in step 505, and then determines whether a UI state storage event occurs in a UICP 400, in step 509. When the UI state storage event does not occur, the first RUIC 200 again determines whether the UI state storage event occurs, in step 509.

When the UI state storage event occurs, the RUIC 200 stores a UI state of a current UI page, in step 511, and transmits a UI list for the stored UI state to the RUIS 250, in step 513. Accordingly, the RUIS 250 receives and stores the UI list, in step 515.

In step 517, the first RUIC 200 determines whether to store the UI state in the RUIS 250. When the first RUIC 200 has determined not to store the UI state in the RUIS 250, it transmits the UI state to the second RUIC 230, in step 519. Accordingly, in step 521, the second RUIC 230 receives and stores the UI state from the first RUIC 200.

In contrast, when the first RUIC 200 has determined to store the UI state of the first RUIC 200 in the RUIS 250, it transmits the UI state of the first RUIC 200 to the RUIS 250, in step 523. Accordingly, the RUIS 250 receives and stores the UI state of the first RUIC 200, in step 525.

After passage of a predetermined time, the RUIS 250 determines whether the stored UI list is requested from the UICP 400, in step 529. When the stored UI list is not requested, step 519 is repeated. When the stored UI list is requested, the RUIS 250 transmits the stored UI list to the UICP 400 in step 531.

The UICP 400 receives the UI list from the RUIS 250, in step 533, and requests restoration of the UI state of the UI list received previously through the first RUIC 200, in step 535. When the second RUIC 230 receives the request for restoration of the UI state from the UICP 400, it requests an original UI page from the RUIS 250, in step 537. The RUIS 250 generates and transmits the original UI page to the second RUIC 230 in response to the request for the UI page, in step 539.

The second RUIC 230 receives the original UI page from the RUIS 250, in step 541, and determines whether the UI state of the first RUIC 200 is stored in the RUIS 250, in step 543.

If the UI state of the first RUIC 200 is stored in the RUIS 250, the second RUIC 200 requests transmission of the stored UI state of the first RUIC 200 to the RUIS 250, in step 547. In step 547, the second RUIC 230 transmits the capability of the second RUIC 230 to the RUIS 250 simultaneously with a request for transmission of the UI state. In step 549, the RUIS 250 controls the stored UI state of the first RUIC 200 according to the capability of the second RUIC 230, and transmits the controlled UI state of the first RUIC 200 to the second RUIC 230. Accordingly, the second RUIC 230 receives the controlled UI state of the first RUIC 200, in step 551, applies the controlled UI state to an original UI page provided from the RUIS 250, and provides the original UI page to a browser of the RUIC 2, in step 553.

In contrast, if the UI state of the first RUIC 200 is not stored in the RUIS 250 (that is, the UI state of the first RUIC 200 is stored within the second RUIC 200), the second RUIC 200 controls the stored UI state of the first RUIC 200 according to the capability of the second RUIC 230, in step 545. The second RUIC 200 applies the controlled UI state to the original UI page provided from the RUIS 250 and provides the original UI page to a browser of the RUIC 2, in step 553.

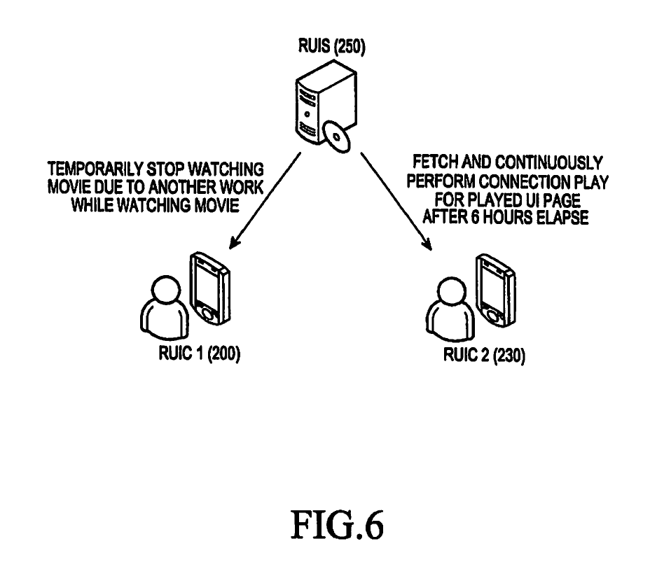

A user can use RUICs as illustrated in FIG. 6.

FIG. 6 is a diagram illustrating application of the method for providing a UI page, according to an embodiment of the present invention.

Referring to FIG. 6, when a user temporarily stops watching a movie using the first RUIC 200, the RUIS 250 transmits a UI state containing a current playback location and the display size to the second RUIC 230. This allows the user to continuously watch a previously watched movie through the second RUIC 230 after a predetermined time elapses.

Embodiments of the present invention may efficiently provide a UI page in a home network.

Moreover, in embodiments of the present invention, if power of a first RUIC is turned-off, the user may continuously use a previously received service through a second RUIC.

Meanwhile, various other effects are explicitly or implicitly disclosed in the foregoing description of embodiments of the present invention.

While the invention has been shown and described with reference to certain embodiments thereof, it will be understood by those skilled in the art that various changes in form and detail may be made therein without departing from the spirit and scope of the invention as defined by the appended claims.

1. A method for providing User Interface (UI) page in a home network, the method comprising the steps of:
receiving, at a first client, a UI page from a server;
transmitting a UI state of a current UI page from the first client to the server or a second client to store the UI state of the current UI page in the server or the second client, when a UI state storage event for storing the UI state of the current UI page occurs; and
when a request for restoration of the UI state is generated by the second client, controlling the UI state according to a capability of the second client by the server or the second client, and applying the controlled UI state to the UI page received from the server by the second client.

2. The method of claim 1, wherein transmitting the UI state of the current UI page comprises:
storing, by the first client, the UI state in the first client when the UI state storage event occurs; and
transmitting the UI state and a UI list of the UI state from the first client to the sever to store the UI state and the UI list in the server.

3. The method of claim 2, wherein applying the controlled UI state comprises:
receiving, at the second client, an original UI page suitable for the second client from the server when the request for restoration of the UI state is generated, and making a request for transmission of the UI state to the server by the second client;
controlling the UI page according to the capability of the second client and transmitting the controlled UI page from the server to the second client; and
applying the controlled UI page to the original UI page received from the server by the second client.

4. The method of claim 3, wherein making the request for transmission of the UI state comprises making a request for transmission of the UI state including the capability of the second client.

5. The method of claim 1, wherein transmitting the UI state of the current UI page comprises:
storing, by the first client, the UI state in the first client, when the UI state storage event is generated;
transmitting a UI list of the UI state from the first client to the server; and
transmitting the UI state from the first client to the second client to store the UI state in the second client.

6. The method of claim 5, wherein applying the controlled UI state comprises:
receiving, at the second client, a UI page of the second client from the server, when the request for restoration of the UI state is generated;
controlling by the second client, the UI state according to the capability of the second client; and
applying, by the second client, the controlled UI state to the UI page received from the server.

7. An apparatus for providing a User Interface (UI) page in a home network, the apparatus comprising:
a first client for receiving a UI page from a server, and transmitting a UI state of a current I UI page to the server or a second client to store the UI state of the current UI page in the server or the second client when a UI state storage event for storing the UI state of the current UI page occurs; and
the second client for applying a UI state, having been controlled according to a capability of the second client, to the UI page received from the server when a request for restoring the UI state is generated.

8. The apparatus of claim 7, wherein, when the UI state storage event occurs, the first client stores the UI state in the first client and transmits the UI state and a UI list of the UI state to the sever to store the UI state and the UI list in the server.

9. The apparatus of claim 8, wherein the second client receives the UI page from the server when the request for restoration of the UI state is generated, makes a request for transmission of the stored UI state to the server, receives a UI page controlled according to the capability of the second client from the server, and applies the controlled UI page to the original UI page received from the server.

10. The apparatus of claim 9, wherein the second client makes a request for simultaneous transmission of the capability of the second client together with the UI state to the server.

11. The apparatus of claim 7, wherein, when the UI state storage event is generated, the first client stores the UI state within the first client, transmits a UI list of the UI state to the server, and transmits the UI state to the second client to store the UI state at the second client.

12. The apparatus of claim 11, wherein, when the request for restoration of the UI state is generated, the second client receives the UI page from the server, controls the UI state according to the capability of the second client, and applies the controlled UI state to the UI page received from the server.
